(19) United States
(12) Patent Application Publication
(10) Pub. No.: US 2006/0068137 A1
(43) Pub. Date: Mar. 30, 2006

(54) Flexible, inflatable packaging materials with decorative borders and methods of making and using same

(76) Inventors: Donald E. Weder, Highland, IL (US); Michael R. Klemme, Maryville, IL (US)

Correspondence Address: DUNLAP, CODDING & ROGERS P.C., PO BOX 16370, OKLAHOMA CITY, OK, 73113, US

(21) Appl. No.: 11/283,008

(22) Filed: Nov. 18, 2005

Related U.S. Application Data
(63) Continuation of application No. 10/383,413, filed on Mar. 7, 2003.
Application No. 10/383,413 is a continuation-in-part of application No. 09/934,301, filed on Aug. 21, 2001, now Pat. No. 6,534,136.

(51) Int. Cl. B32B 27/32

(52) U.S. Cl. 428/35.2

(57) ABSTRACT

The present invention relates generally to packaging materials for packaging articles, and more particularly, but not by way of limitation, to a packaging material which includes, in one embodiment, a plurality of individual strips, strands, or units of material bondably connected to the exterior surface of a flexible, inflatable substrate to form a cohesive inflatable cushioning unit for use as a packaging material.

### CROSS-REFERENCE TO RELATED APPLICATIONS

This application is a continuation of U.S. Ser. No. 10/383,413, filed Mar. 7, 2003, which is a continuation-in-part of U.S. Ser. No. 09/934,301, filed on Aug. 21, 2001, now U.S. Pat. No. 6,534,136, the contents of which are expressly incorporated herein in their entirety by reference.

### BACKGROUND OF THE INVENTION

1. Field of the Invention

The present invention relates generally to packaging materials for packaging articles, and more particularly, but not by way of limitation, to a packaging material which includes, in one embodiment, a decorative border and a plurality of individual strips, strands, or units of material bondably connected to the exterior surface of a flexible, inflatable substrate to form a cohesive inflatable cushioning unit for use as a packaging material.

2. Brief Description of the Related Art

In the process of shipping an article from one location to another, the article is typically placed in a container along with a protective packaging material to fill the voids about the article and to cushion the article during the shipping process. One common protective packaging material is comprised of a plurality of plastic foam, peanut-shaped members which are commonly known as “Styrofoam peanuts.” An advantage in using Styrofoam peanuts is the ease with which they may be disposed about an article positioned in a container by simply pouring the Styrofoam peanuts from a dispenser.

While Styrofoam peanuts have been widely accepted in the packaging industry, they are not without disadvantages. For example, their light weight and flowability results in heavier objects gravitating through the peanuts to the bottom of the container where the heavier objects can be damaged. Also, while the flowability of the Styrofoam peanuts facilitates the introduction of the peanuts into a container, the receiver of the package is left with having to deal with cleaning up the mess left by the peanuts which are easily scattered upon removal of the article from the container.

These and other disadvantages associated with the disposal of Styrofoam peanuts, has made paper protective packaging material a popular alternative. Paper is biodegradable, recyclable, and renewable therefore making it an environmentally responsible choice. However, like Styrofoam peanuts, paper packaging materials is not without disadvantages. Paper, particularly shredded paper, can be inconvenient to clean up and to dispose of due to the lack of cohesiveness of the packaging material. Due to the lack of resiliency in paper products, large amounts of paper are typically required to provide the bulk needed to adequately cushion an object.

Strips of sheet material formed into tufts have also been used for many years as a packaging material. More specifically, material known as decorative grass has been used in fruit baskets, Easter baskets, picnic baskets, and for other packaging and decorative purposes. The decorative grass of the prior art has been produced by numerous methods and from a variety of materials such as polymeric materials, paper, cellophane or the like. Typically, such materials are cut and shredded to produce segments having predetermined dimensions. As such, decorative grass, like Styrofoam peanuts and paper materials described above, can be inconvenient to clean up. Furthermore, the decorative grass can compress and lose its cushioning ability. Large amounts of decorative grass are necessary, therefore, in order to overcome such compression and/or compaction deficiencies.

To this end, a packaging material is needed that includes or mimics a plurality of resilient individual strips, strands, or units of material 30 intertwined with one another or other organic or inorganic materials that may be bondably connected to a flexible inflatable substrate so as to form a unitary cushioning unit which overcomes the above-mentioned disadvantages of prior art packaging materials and has the added benefit of providing a decorative border. It is to such a packaging material that the present invention is directed.

### BRIEF SUMMARY OF THE INVENTION

The present invention relates, generally, to a packaging material for use in filling boxes, baskets, and in any container used to protect, store, and/or ship articles or objects. In one embodiment, the packaging material includes an inflatable flexible bag having an interior surface and an exterior surface wherein the exterior surface has attached thereto a mass of individual, thin, flexible strips, strands, or units of material intertwined with one another to form a cohesive, resilient tuft. The mass of individual strips, strands, or units of material may also be attached to one another as well as being disposed on the exterior surface of the inflatable flexible bag. Other embodiments are also contemplated for use and are disclosed herein. In an alternate embodiment the inflatable flexible bag is exchanged or replaced by a flexible inflatable substrate.

The packaging material formed according to the methods disclosed herein may be incorporated into a package which additionally includes a container, such as a box or basket, and an object positioned within the container and on top of the packaging material. The packaging material is arranged in the container to support the object when the object is disposed in the container. The inflatable flexible bag may be caused to bond to the container and the object may be caused to bond to the packaging material. In use, the packaging material is substantially inflated so as to take up excess room in the container and protect and/or cushion the object.

The objects, features and advantages of the present invention will become apparent from the following detailed description when read in conjunction with the accompanying drawings and appended claims.

### BRIEF DESCRIPTION OF THE SEVERAL VIEWS OF THE DRAWING

FIG. 1 is a perspective view of an inflatable packaging material (in its uninflated configuration) constructed in accordance with the present invention.

FIG. 2 is an exploded view of the inflatable packaging material of FIG. 1.

FIG. 2A is a perspective view of the inflatable packaging material of FIG. 1 in its inflated configuration.

FIG. 3 is a perspective view of a strip, strand, or unit of material used to form the tuft of FIG. 2.

FIG. 4 is a schematic representation of a system for making the strip, strand, or unit of material of FIG. 3.

FIG. 5 is a perspective view of a basket having the inflatable packaging material disposed therein with a plurality of objects or articles displayed or cushioned thereon.

FIG. 6 is a perspective view of another embodiment of the inflatable packaging material constructed in its inflated configuration in accordance with the present invention.

FIG. 7 is a perspective view of a tall package illustrating the inflatable packaging material of FIG. 6 cushioning an article during a shipping process.

FIG. 8 is an elevational view of another embodiment of the packaging material constructed in accordance with the present invention.

FIG. 9 is a cross-sectional view of the inflatable packaging material of FIG. 8.

FIG. 10 is a perspective view of a basket showing the inflatable packaging material of FIG. 9 inserted therein.

FIG. 11 is a perspective view of a strip, strand, or unit of material used to form a tuft of the inflatable packaging material of the present invention.

### DETAILED DESCRIPTION OF THE INVENTION

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways and as such all such embodiments and/or equivalents are to be considered as being encompassed within the scope and description of the present invention. Also, it is to be understood that the phraseology and terminology employed herein is for purpose of description and should not be regarded as limiting.

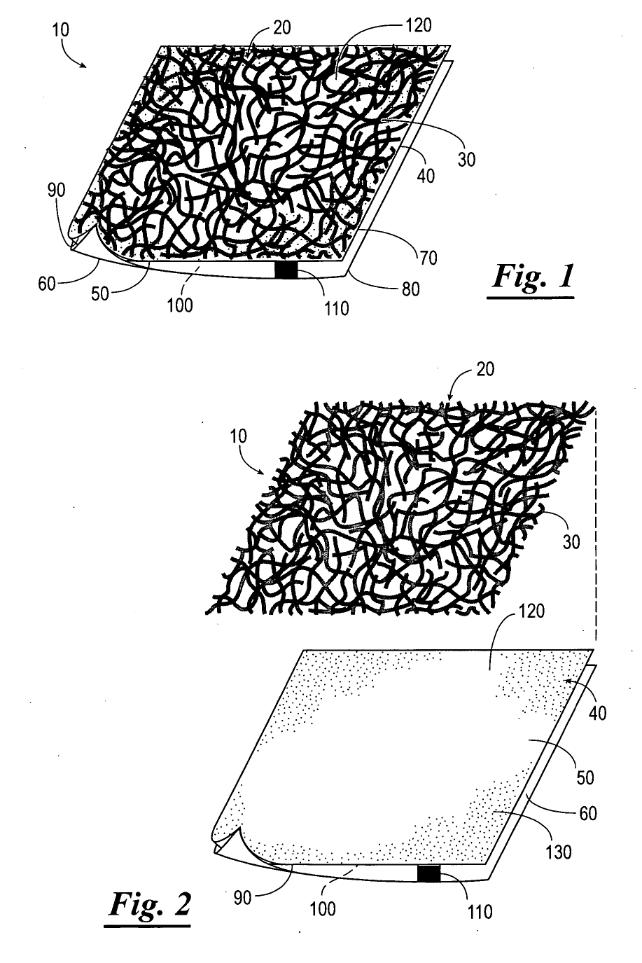

Referring now to the drawings, and more specifically to FIGS. 1-3, an inflatable packaging material 10 constructed in accordance with the present invention is illustrated in FIG. 1. The inflatable packaging material 10 includes a tuft 20 comprised of a plurality of individual strips, strands, or units of material 30 (FIG. 3) bondably connected to a flexible inflatable substrate 40. The plurality of individual strips, strands, or units of material 30 can be fabricated from any flexible sheet of material including paper, crepe paper, polymeric film, laminated polymeric film, and waxed paper, for example. The flexible sheet of material from which the plurality of individual strips, strands, or units of material 30 are fabricated may have printed matter and/or one or more embossed patterns on at least one side thereof, and the one or more embossed patterns may be either in register or out of register with the printed pattern.

The plurality of individual strips, strands, or units of material 30 may also be organic or inorganic materials, including leaves, tree bark, branches, dirt, sand, sea shells, or any other type of organic or inorganic material that is capable of being bondably connected to the flexible inflatable substrate 40 to provide a decorative and/or cushioning effect. Furthermore, when the plurality of individual strips, strands, or units of material 30 are fabricated from a flexible sheet of material, additional inorganic and/or organic materials may be attached onto or be incorporated into or within the flexible sheet of material prior to or after its being used to fabricate the plurality of individual strips, strands, or units of material 30.

The printed pattern on the flexible sheet of material from which the plurality of individual strips, strands, or units of material 30 are fabricated can be printed in a conventional matter so that, when the sheet of material is slit and cut to produce the strips, strands, or units of material 30, at least a substantial portion of the strips, strands, or units of material 30 contain at least a portion of the printed pattern. Further, different colors can be employed to provide the printed pattern on the sheet of material from which the plurality of individual strips, strands, or units of material 30 are fabricated.

The sheet of material can also have one or more embossed patterns to provide the sheet of material with an embossed pattern. Further, the sheet of material can be provided with an embossed pattern as well as a printed pattern, and the embossed pattern can be either in register or out of register with the printed material and/or printed design.

The plurality of individual strips, strands, or units of material 30, as described above, in one embodiment are commonly referred to as strands, or units of “Easter grass” or “decorative grass”, and such, decorative grass has been used for many years for filling fruit baskets, Easter baskets, and picnic baskets and for other decorative and packaging purposes. The decorative grass of the prior art has been produced by numerous methods and from a variety of materials, such as those listed above. Typically, such materials are shredded and cut to produce segmented strips having predetermined dimensions. While the prior art methods for making decorative grass have been widely accepted, new techniques for facilitating the use of decorative grass as a packaging material have been sought in view of the fact that decorative grass and other loose shredded packaging material readily fall onto the floor, cling to various objects making them awkward and inconvenient to clean up, and compact and thereby no longer adequately cushion and/or protect the items placed thereon.

By connecting the tuft 20 (composed of a plurality of the strips, strands, or units of material 30) to the flexible inflatable substrate 40, the clean up problems associated with loose fill materials are alleviated and, because the flexible inflatable substrate 40 is capable of being inflated, the compacting problems with loose fill are also alleviated and lesser amounts of material are required. The flexible inflatable substrate 40 can also be caused to adhere or cohere to an object and/or the container in which it is placed thereby resulting in an enhanced packaging effect. That is, with loose packaging materials, the object being packaged has a tendency to gravitate through the packaging material to the bottom of the container thereby reducing the effectiveness of the packaging material. By using the inflatable packaging material 10 disclosed herein, the cohesiveness of the inflatable packaging material 10 surrounding the object prevents the object from gravitating through the container and coming to rest in the bottom of the container.

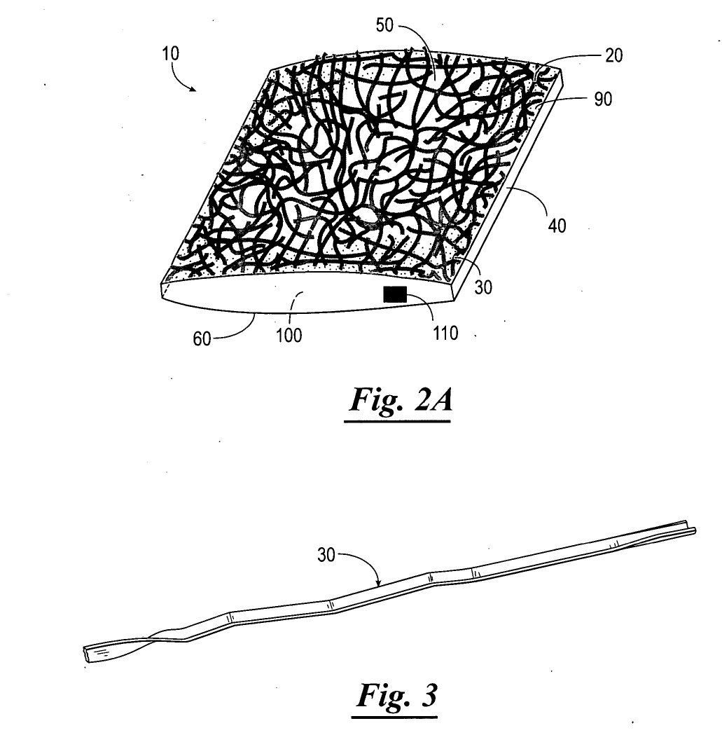

As best shown in FIG. 2, the flexible inflatable substrate 40, in one embodiment, is fabricated of a first sheet of material 50 and a second sheet of material 60. It will be appreciated that the dimensions of the flexible inflatable substrate 40 may be further varied and the shape of the flexible inflatable substrate 40 may also, therefore, be variable—e.g. a circle, square, triangle, heart, an animal shape, a floral shape, etc. The flexible inflatable substrate 40 can be any flexible sheet of material, such as paper, crepe paper, wax paper, polymeric film, laminated polymeric film, fabric, cellulose, and foil. The flexible inflatable substrate 40 may have printed matter and/or one or more embossed patterns on at least one side thereof, and the one or more embossed patterns can be either in register or out of register with the printed pattern. Different colors can be employed to provide the printed pattern on the flexible inflatable substrate 40. For example, the printed pattern may be a pictoral representation or color or shape of the plurality of individual strips, strands, or units of material 30 such that when a small amount of the plurality of individual strips, strands, or units of material 30, forming the tuft 20 are bonded to the flexible inflatable substrate 40, the printed pattern fills in the voids between the plurality of individual strips, strands, or units of material 30 such that it appears that there are few or no actual voids of the plurality of individual strips, strands, or units of material 30 on the flexible inflatable substrate 40 thereby resulting in an aesthetically pleasing inflatable packaging material 10 that appears to be fully covered with the individual strips, strands, or units of material 30.

The flexible inflatable substrate 40 can also be embossed so as to provide the flexible inflatable substrate 40 with an embossed pattern. Further, the flexible inflatable substrate 40 can be provided with one or more embossed patterns as well as a printed pattern, and the one or more embossed patterns can be either in register or out of register (or partially both) with the printed material.

The first sheet of material 50 and the second sheet of material 60 of the flexible inflatable substrate 40 may be constructed of a single layer of material or a plurality of layers of the same or different types of materials. In addition, any thickness of the first sheet of material 50 and the second sheet of material 60 of the flexible inflatable substrate 40 may be utilized with the present invention. The first sheet of material 50 has an outer peripheral edge 70 and the second sheet of material 60 has an outer peripheral edge 80. The outer peripheral edge 70 of the first sheet of material 50 is bonded via a bonding material 90 to the outer peripheral edge 80 of the second sheet of material 60 to provide and define an expandable interior inflation space 100. Means for inflating 110 the flexible inflatable substrate 40 is placed within the expandable interior inflation space 100.

The means for inflating 110 the flexible inflatable substrate 40 may be any composition or assembly capable of inflating the expandable interior inflation space 100 to provide and place the inflatable packaging material 10 in its inflated configuration. For example, the means for inflating 110 the flexible inflatable substrate 40 may be associated with an exterior surface 120 of the flexible inflatable substrate 40 and be in fluid communication with the expandable interior inflation space 100—e.g. a tube capable of being sealed off after air and/or other gases and/or liquids are passed into the expandable interior inflation space 100.

In an alternative embodiment the means for inflating 110 the expandable interior inflation space 100 is an exothermic reaction assembly wherein, when the exothermic reaction assembly is activated, an exothermic reaction takes place thereby producing a gas capable of filling at least a portion of the expandable interior inflation space 100 of the flexible inflatable substrate 40. The exothermic reaction assembly may further include at least two chambers wherein at least one other chamber contains a weak basic composition and at least one chamber contains a weak acid composition that, when brought into reactive contact with one another (e.g. breaking each open to intermix the weak acid composition with the weak basic composition), react and form a gaseous reaction product that substantially fills the expandable interior inflation space 100 of the flexible inflatable substrate 40. The weak basic composition may in one embodiment include a Group I or Group II element. For example, the weak basic composition may be selected from the group consisting of sodium carbonate, calcium carbonate, and combinations thereof. The weak acid may be vinegar. Although certain compositions have been set forth as being included in the exothermic reaction assembly, any combination of compositions that, when placed in reactive contact with one another, produce a gaseous reaction that substantially fills the expandable interior inflation space 100 of the flexible inflatable substrate 40 are considered for use.

Although the flexible inflatable substrate 40 is shown in FIGS. 1-2 as being square, the flexible inflatable substrate 40 may be any shape. For example, the flexible inflatable substrate 40 may be square, rectangular, circular or any other geometric or fanciful shape. The shape of the flexible inflatable substrate 40 may even have an irregular, capricious or decorative shape.

To receive the tuft 20, the exterior surface 120 of the flexible inflatable substrate 40 is coated with a bonding material 130 (which may be the same as the bonding material 90) such as an adhesive or cohesive whereby the tuft 20 is caused to bond to the exterior surface 120 of the flexible inflatable substrate 40 as illustrated in FIG. 1. As shown in FIG. 2, the bonding material 130 is disposed on the entire exterior surface 120 of the flexible inflatable substrate 40—i.e. on each of the first sheet of material 50 and the second sheet of material 60. Alternatively, the bonding material 130 may be applied in such a manner as to substantially coat only one of the first sheet of material 50 or the second sheet of material 60 of the flexible inflatable substrate 40. It will be further appreciated that the bonding material 130 may be disposed on the first sheet of material 50 and/or the second sheet of material 60 in any of a variety of patterns such as strips, circles, dots or any other geometric or biomorphic shape, including decorative designs, so long as the bonding material 130 is positioned to function in accordance with the present invention.

The term “bonding material” as used herein can mean an adhesive, frequently a pressure sensitive adhesive, or a cohesive or any adhesive/cohesive combination, having adhesive qualities (i.e., qualities of adhesion or adhesion/cohesion, respectively) sufficient to effect the connection between portions of the tuft 20 brought into engagement with the flexible inflatable substrate 40. It will be appreciated that both adhesives and cohesives suitable for the purposes described herein are well known in the art, and both are commercially available.

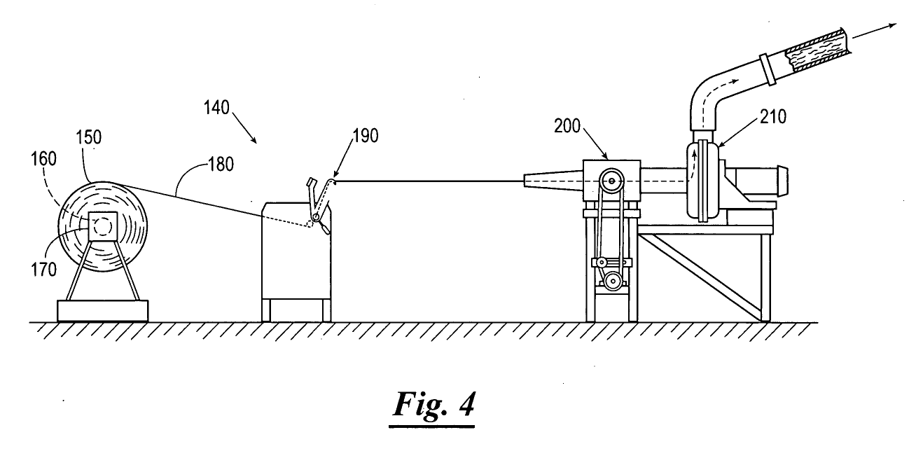

FIG. 4 schematically illustrates a system 140 for making the individual strips, strands, or units of material 30 in accordance with the present invention. The system 140 includes a roll of material 150 supported on a shaft 160 having a brake assembly 170 operably connected thereto for controlling the rate of withdrawal of the roll of material 150.

The roll of material 150 provides a web of sheet material 180 which is passed through a slitter 190. The slitter 190 includes a plurality of spaced apart, stationary knives or other conventional cutting mechanism, which slit or cut the web of sheet material 180 into the individual strips, strands, or units of material 30 of into a desired width.

The slitted web of sheet material 180 is thereafter passed into a cutter 200 where the slitted web of sheet material 180 is cut into predetermined lengths so as to form the individual strips, strands, or units of material 30. From the cutter 200, the individual strips, strands, or units of material 30 are conveyed by a conveyor unit 210, which is in the form of a centrifugal blower, to a storage area (not shown) which may be in the form of a suitable bin, packaging machine, or the like.

As an alternative to forming the individual strips, strands, or units of material 30 from the roll of material 150, it will be appreciated that the individual strips, strands, or units of material 30 may be formed from a polymeric film discharged from a film extrusion die which is then chilled prior to the slitting process. Such a method is disclosed in U.S. Pat. No. 4,292,266, entitled “Process for Making Decorative Grass”, issued to Weder et al. on Sep. 29, 1981, which is hereby expressly incorporated herein in its entirety by reference.

As illustrated in FIG. 3, the individual strips, strands, or units of material 30 tend to curl and form folds during the forming process. It will be appreciated that these curls and folds contribute to the resiliency and bulkiness or fluffiness of the tuft 20 produced by amassing and intertwining a plurality of the individual strips, strands, or units of material 30. It will be further appreciated that the degree to which the individual strips, strands, or units of material 30 are curled and folded can vary dependent on several factors, such as the type of material used to form the individual strips, strands, or units of material 30.

To assemble the inflatable packaging material 10, the individual strips, strands, or units of material 30 are amassed and intertwined to form the tuft 20 and then the tuft 20 is bondably connected to the flexible inflatable substrate 40 (FIG. 2). Thereafter, and as shown in FIG. 2A, the means for inflating 110 is activated such that the expandable interior inflation space 100 is inflated and the inflatable packaging material 10 is provided.

FIG. 5 illustrates one use of the inflatable packaging material 10 described above. The inflatable packaging material 10 is shown in its inflated configuration after the means for inflating 110 has been activated (i.e. the expandable interior inflation space 100 is inflated) and is disposed in a basket 220 to support a plurality of articles or objects 230, such as candies or Easter eggs, for display. More specifically, the inflatable packaging material 10 is positioned in an interior 240 of the basket 220 such that the flexible inflatable substrate 40 substantially conforms to the contour of the interior 240 of the basket 220 thereby lining the interior 240 of the basket 220 with the individual strips, strands, or units of material 30 forming the tuft 20 that is bonded to the flexible inflatable substrate 40 to form the inflatable packaging material 10. If the second sheet of material 60 of the flexible inflatable substrate 40 is provided with the bonding material 22, the second sheet of material 60 of the flexible inflatable substrate 40 can be bondably connected to the interior 240 of the basket 220. In addition, the bonding material 22 on the second sheet of material 60 of the flexible inflatable substrate 40 causes the inflatable packaging material 10 to remain in place in the basket 220. If the second sheet of material 60 of the flexible inflatable substrate 40 is not provided with the bonding material 22, the flexible inflatable substrate 40 simply rests in the interior 240 of the basket 220.

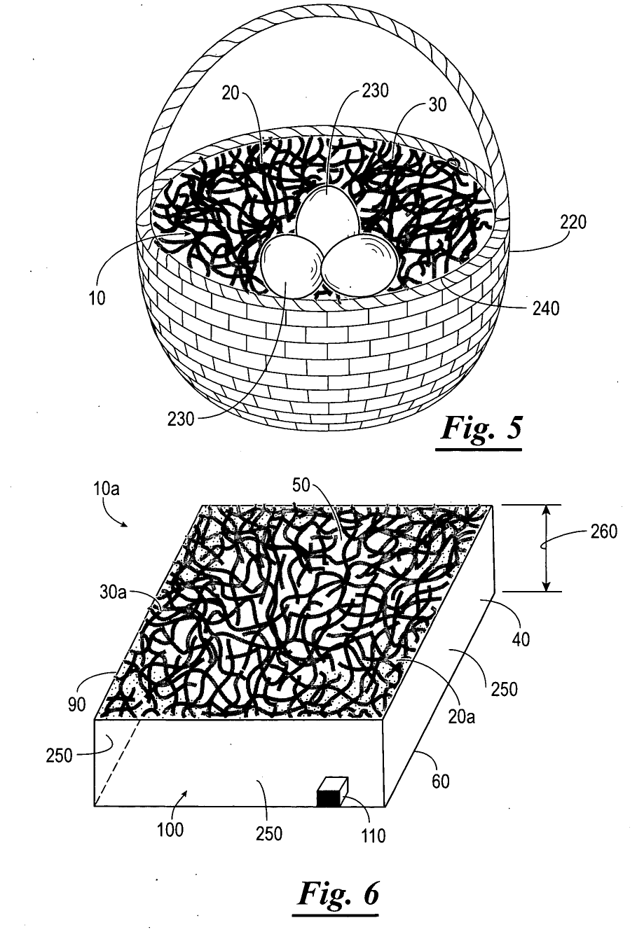

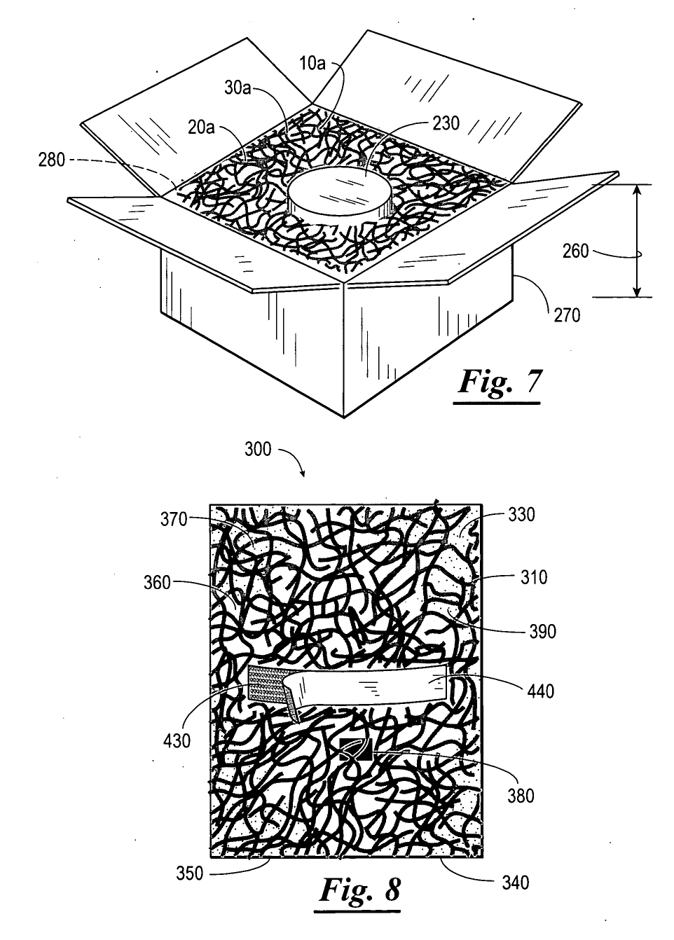

FIG. 6 illustrates a modified inflatable packaging material 10a which is identical in construction to the inflatable packaging material 10 illustrated in FIG. 1 with the exception that the inflatable packaging material 10a has elongated sidewalls 250 that upon activating the means for inflating 110 the expandable interior inflation space 100 provide the inflatable packaging material 10a with a height 260. The tuft 20 may be connected to the first sheet of material 50 and/or the second sheet of material 60 and/or the elongated sidewalls 250. It will be appreciated that such a configuration will facilitate insertion of the inflatable packaging material 10a into a tall square container. For example, FIG. 7 illustrates the inflatable packaging material 10a disposed in a tall square container 270 so as to provide an interior 240a of the tall square container 270 with an inflatable packaging material 10a. The inflatable packaging material 10a is being used as a packaging material for protecting an article 46 disposed in the tall square container 270. In this manner, the tuft 20 of the inflatable packaging material 10a functions to cushion the plurality of articles or objects 230 during transport.

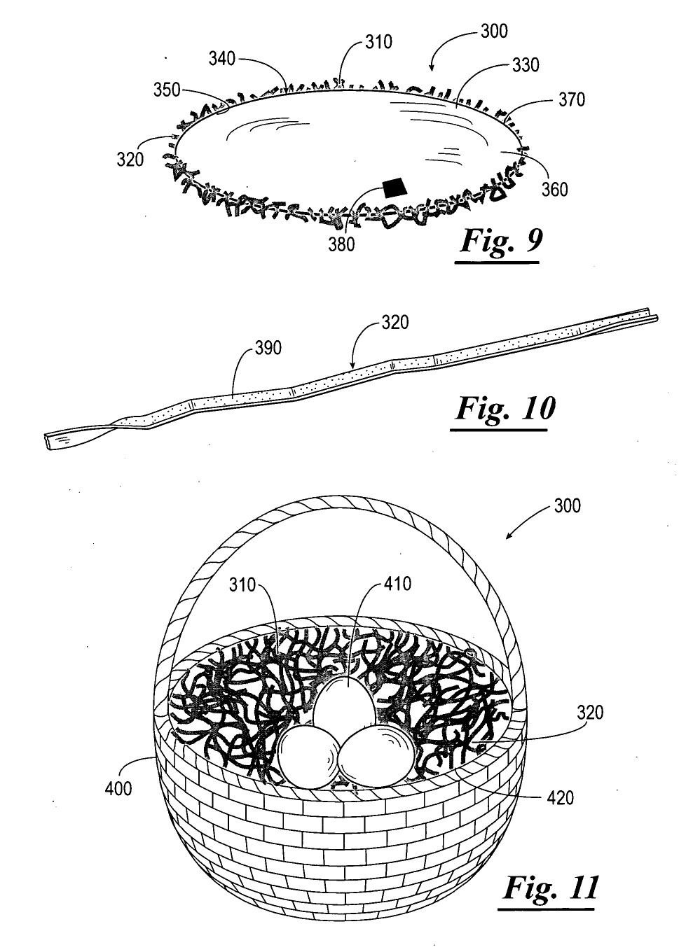

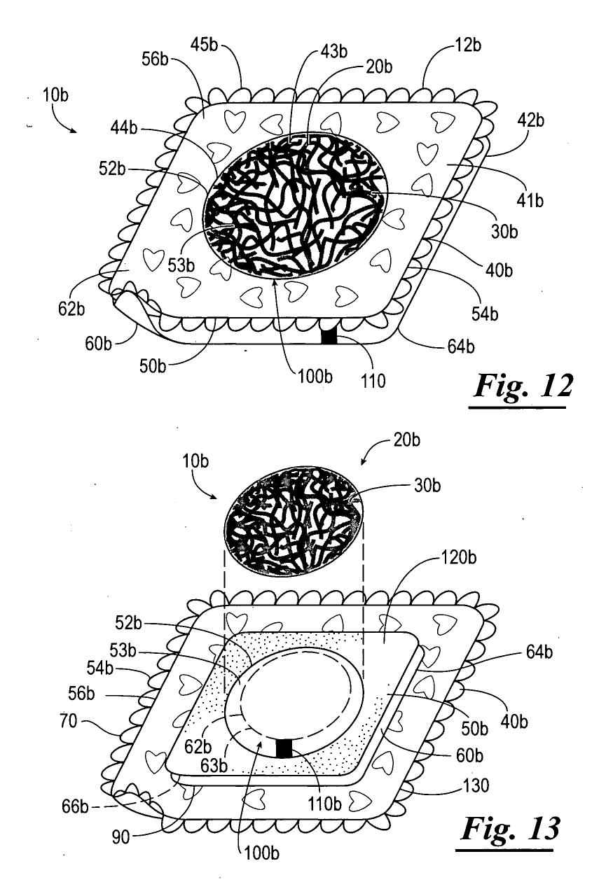

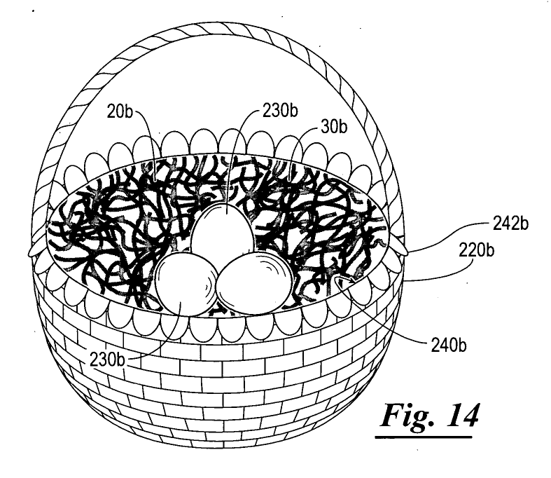

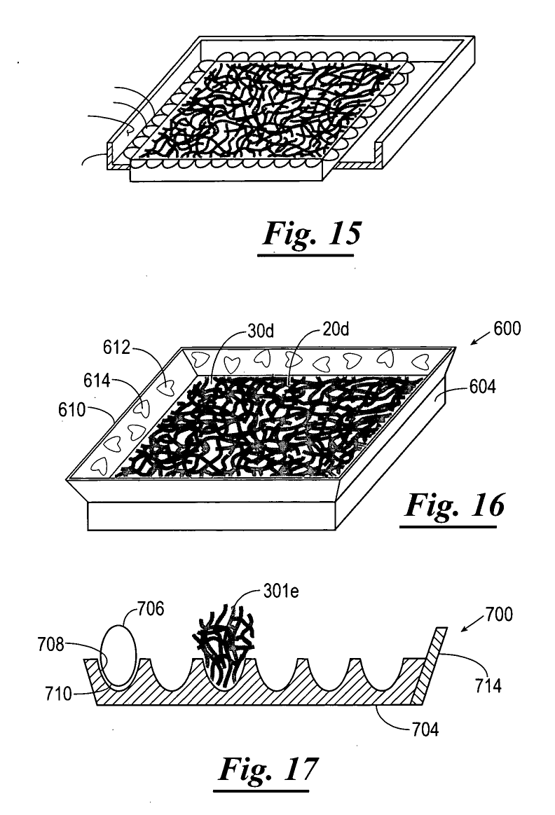

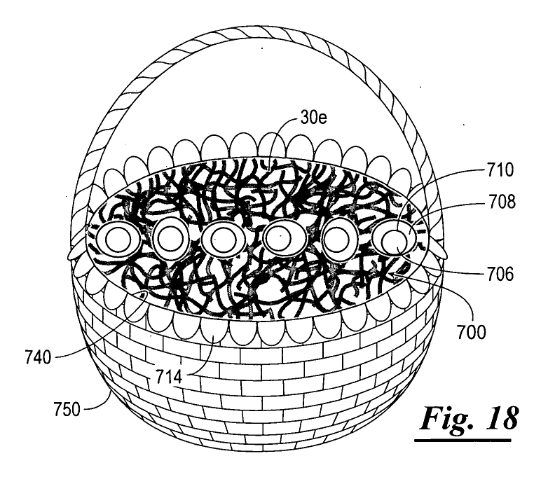

Referring now to FIGS. 9 and 10, an inflatable packaging material 300 constructed in accordance with the present invention is illustrated. The inflatable packaging material 300 includes a tuft or mass 310 of individual, thin, flexible strips, strands or units of material 320, commonly referred to as decorative grass or Easter grass (although the tuft 310 may be fabricated from the same or similar material as tuft 20 disclosed hereinabove), disposed upon an exterior surface 330 of an flexible inflatable bag 340. It will be appreciated that tufts of decorative grass are often packaged loosely in a bag whereby when it is desired to utilize the decorative grass, the bag is opened and the grass removed. The inflatable packaging material 300 is unique in that the flexible inflatable bag 340 is used in conjunction with the tuft 310 on the exterior surface 330 in a manner similar to that described above in relation to the inflatable packaging material 10. That is, in addition to functioning as a substrate for the tuft 310, the flexible inflatable bag 340 is capable of being inflated while holding the tuft 310 to thereby clean up the problems associated with loose fill materials and provide a more economical and cushioning packaging material.

The structure of the flexible inflatable bag 340 can be that of any flexible inflatable bag suitable for being used in a packaging manner. For example, the flexible inflatable bag 340 can be fabricated from a sheet of material having a relatively small thickness and being of the type commonly referred to in the art as a “film”. More particularly, the sheet of material can be a processed, man-made organic polymer film selected from the group of films consisting of polypropylene, polyvinyl chloride, or combinations thereof. However, it is to be noted that the sheet of material may also be constructed from a material selected from a group of materials consisting of plastic film, cellophane, paper, cloth, or combinations thereof. Alternatively, the flexible inflatable bag 340 may be of the type used typically to package sandwiches, such as a Glad ™ sandwich bag. The flexible inflatable bag 340 may also be a corsage bag, a balloon, a water storage bag, or any flexible bag or container that is capable of being inflated.

The flexible inflatable bag 340 is characterized as having the exterior surface 330 as well as an interior surface 350 with the interior surface 350 defining an expandable interior inflation space 360. As best shown in FIG. 10, the exterior surface 330 of the flexible inflatable bag 340 is coated with a bonding material 370, such as an adhesive or cohesive, whereby the tuft 310 is caused to bond to the exterior surface 330 of the flexible inflatable bag 340 upon being disposed on the flexible inflatable bag 340. The flexible inflatable bag 340 illustrated in FIG. 10 has the bonding material 370 disposed on substantially the entire exterior surface 330. Alternatively, the bonding material 370 may be applied in such a manner as to substantially coat only a portion of the exterior surface 330 of the flexible inflatable bag 340. It will be further appreciated that the bonding material 370 may be disposed on the exterior surface 330 of the flexible inflatable bag 340 in any of a variety of patterns such as strips, circles, dots or any other geometric or biomorphic shape, including decorative designs, so long as the bonding material 370 is positioned to function in accordance with the present invention. The tuft 310 is disposed on the flexible inflatable bag 340 in any manner which is known in the art, such as automatically passing the tuft 310 through a tube (not shown) which is disposed generally above the flexible inflatable bag 340, or the flexible inflatable bag 340 may be dipped, rolled, or dropped into a plurality of tufts 310 such that the tufts 310 stick to the exterior surface 330 of the flexible inflatable bag 340.

Upon the tuft 310 being placed onto the flexible inflatable bag 340, the tuft 310 will bondingly connect to the exterior surface 330 of the flexible inflatable bag 340 via the bonding material 370. After the tuft 310 has been disposed onto the flexible inflatable bag 340, the flexible inflatable bag 340 may be inflated via a means for inflating 380 the flexible inflatable bag 340 disposed in the expandable interior inflation space 360 to form the inflatable packaging material 300. The means for inflating 380 the flexible inflatable bag 340 is the same as the means for inflating 110 the flexible inflatable substrate 40 of the inflatable packing material 10 as described hereinabove. It should be appreciated that with the tuft 310 disposed on the flexible inflatable bag 340, the flexible inflatable bag 340 can be stored, transported, and displayed in a conventional manner when it is in its inflated configuration or in its non-inflated configuration.

In addition to, or as an alternative to coating the exterior surface 330 of the flexible inflatable bag 340 with the bonding material 370, the tuft 310 may be connected to the exterior surface 330 of the flexible inflatable bag 340 via a bonding material 390 (FIG. 13) provided on the individual strips, strands, or units of material 320 making up the tuft 310. The bonding material 390 may be an adhesive or cohesive whereby the individual strips, strands, or units of material 320 are caused to stick together when a plurality of the strips, strands, or units of material 320 are amassed to form the tuft 310. The strips, strands, or units of material 320 may be spot coated wherein the bonding material 390 is disposed as randomly disposed spots on the individual strips, strands, or units of material 320. It will be appreciated, however, that the bonding material 390 may be applied in such a manner as to substantially cover the strips, strands, or units of material 320. Further, the bonding material 390 may be disposed on the strips, strands, or units of material 320 in any of a variety of other patterns such as circles, dots or any other geometric or biomorphic shape, including decorative designs, so long as the bonding material 390 is positioned to function in accordance with the present invention.

FIG. 11 illustrates one use of the inflatable packaging material 300 described above. The inflatable packaging material 300 is shown disposed in a basket 400 and supporting a plurality of articles or objects 410, such as candies or Easter eggs, for display. More specifically, a portion of the flexible inflatable bag 340 has been removed so as to expose the tuft 310 while the tuft remains connected to the exterior surface 330 of the flexible inflatable bag 340.

With the flexible inflatable bag 340 inflatable, the inflatable packaging material 300 may then be positioned in an interior 420 of the basket 400 such that the flexible inflatable bag 340 substantially conforms to the contour of the interior 420 of the basket 400 and thereby lines the interior 420 of the basket 400 with the plurality of articles or objects 230 being supported by the tuft 310 and the tuft 310 being held in the basket 400.

It will be appreciated that coating the tuft 310 with a bonding material in the manner discussed above provides an additional advantage of improved object support. That is, with loose packaging materials, objects being packaged often have a tendency to gravitate through the packaging material to the bottom of the container thereby reducing the effectiveness of the packaging material. By providing a bonding material on the individual strips, strands, or units of material 320 making up the tuft 310, the cohesiveness of the tuft 310 supporting the plurality of articles or objects 410 prevent the plurality of articles or objects 410 from gravitating through the tuft 310.

As shown in FIG. 9, the exterior surface 330 of the flexible inflatable bag 340 may also be provided with a bonding material 430. In this instance, the bonding material 430 would be provided with a backing or release strip 440 to protect the bonding qualities of the bonding material 430 and to prevent adjacent bags from bonding to one another during shipping and storage. By providing the exterior surface 330 of the flexible inflatable bag 340 with the bonding material 430 (as shown in FIG. 9), the exterior surface 330 of the flexible inflatable bag 340 can be bondably connected to an interior 420 of the basket 400 to hold the inflatable packaging material 300 in the basket 400. In addition, the bonding material 430 on the exterior surface 330 of the flexible inflatable bag 340 will cause overlapping portions of the flexible inflatable bag 340 to be bondably connected so as to retain the shape of the flexible inflatable bag 340 after it has been shaped to conform to the contour of the interior 240 of the basket 400. If the exterior surface 330 of the flexible inflatable bag 340 is not provided with the bonding material 430, the flexible inflatable bag 340 is simply shaped to conform to the contour of the interior 420 of the basket 400.

In using the inflatable packaging material 300 described above, it should be appreciated that a single unit of the inflatable packaging material 300 can be used in a container or on a surface or multiple units of the inflatable packaging material 300 can be used by either nesting one inflatable packaging material 300 into another inflatable packaging material 300 or otherwise layering one inflatable packaging material 300 on top of another inflatable packaging material 300, thereby increasing the volume and/or density of the inflatable packaging material 300.

From the above description it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and as defined in the appended claims.

What is claimed is:

1. A packaging material, comprising:
a flexible inflatable bag having an exterior surface and an interior surface, the interior surface defining an expandable interior inflation space; and
at least one strip, strand, or unit of material disposed on the exterior surface of the flexible inflatable bag.

2. The packaging material of claim 1, further including means for inflating the flexible inflatable bag.

3. The packaging material of claim 2, wherein the means for inflating the flexible inflatable bag is disposed in the expandable interior inflation space of the flexible inflatable bag.

4. The packaging material of claim 2, wherein the means for inflating the flexible inflatable bag is associated with the exterior surface of the flexible bag and is in fluid communication with the expandable interior inflation space of the flexible inflatable bag.

5. The packaging material of claim 3, wherein the means for inflating the flexible inflatable bag includes an exothermic reaction assembly, wherein when the exothermic reaction assembly is activated, an exothermic reaction takes place thereby producing a gas capable of filling at least a portion of the expandable interior inflation space of the flexible bag.

6. The packaging material of claim 5, wherein the exothermic reaction assembly further includes at least two chambers, wherein at least one of the at least two chambers contains a weak basic composition, and at least one of the at least two chambers contains a weak acid composition.

7. The packaging material of claim 6, wherein the weak basic composition is a composition including a Group I or II element.

8. The packaging material of claim 7, wherein the weak basic composition is selected from the group consisting of sodium carbonate, calcium carbonate, and combinations thereof.

9. The packaging material of claim 6, wherein the weak acid composition is vinegar.

10. The packaging material of claim 1, wherein the exterior surface of the flexible inflatable bag includes a decorative effect.

11. A method of making a packaging material, comprising the steps of:
providing a flexible inflatable bag having an exterior surface and an interior surface, the interior surface defining an expandable interior inflation space; and
providing at least one strip, strand, or unit of material, wherein the at least one strip, strand, or unit of material is disposed on the exterior surface of the flexible inflatable bag to provide a packaging material.

12. The packaging material of claim 11, further including means for inflating the flexible inflatable bag.

13. The packaging material of claim 12, wherein the means for inflating the flexible inflatable bag is disposed in the expandable interior inflation space of the flexible inflatable bag.

14. The packaging material of claim 12, wherein the means for inflating the flexible inflatable bag is associated with the exterior surface of the flexible bag and is in fluid communication with the expandable interior inflation space of the flexible inflatable bag.

15. The packaging material of claim 13, wherein the means for inflating the flexible inflatable bag includes an exothermic reaction assembly, wherein when the exothermic reaction assembly is activated, an exothermic reaction takes place thereby producing a gas capable of filling at least a portion of the expandable interior inflation space of the flexible bag.

16. The packaging material of claim 15, wherein the exothermic reaction assembly further includes at least two chambers, wherein at least one of the at least two chambers contains a weak basic composition, and at least one of the at least two chambers contains a weak acid composition.

17. The packaging material of claim 16, wherein the weak basic composition is a composition including a Group I or II element.

18. The packaging material of claim 17, wherein the weak basic composition is selected from the group consisting of sodium carbonate, calcium carbonate, and combinations thereof.

19. The packaging material of claim 16, wherein the weak acid composition is vinegar.

20. The packaging material of claim 11, wherein the exterior surface of the flexible inflatable bag includes a decorative effect.

21. A flexible, inflatable packaging material produced according to the process comprising the steps of:
providing a flexible inflatable bag having an exterior surface and an interior surface, the interior surface defining an expandable interior inflation space; and
providing at least one strip, strand, or unit of material, wherein the at least one strip, strand, or unit of material is disposed on the exterior surface of the flexible inflatable bag to provide a packaging material.

22. The packaging material of claim 21, further including means for inflating the flexible inflatable bag.

23. The packaging material of claim 22, wherein the means for inflating the flexible inflatable bag is disposed in the expandable interior inflation space of the flexible inflatable bag.

24. The packaging material of claim 22, wherein the means for inflating the flexible inflatable bag is associated with the exterior surface of the flexible bag and is in fluid communication with the expandable interior inflation space of the flexible inflatable bag.

25. The packaging material of claim 23, wherein the means for inflating the flexible inflatable bag includes an exothermic reaction assembly, wherein when the exothermic reaction assembly is activated, an exothermic reaction takes place thereby producing a gas capable of filling at least a portion of the expandable interior inflation space of the flexible bag.

26. The packaging material of claim 25, wherein the exothermic reaction assembly further includes at least two chambers, wherein at least one of the at least two chambers contains a weak basic composition, and at least one of the at least two chambers contains a weak acid composition.

27. The packaging material of claim 26, wherein the weak basic composition is a composition including a Group I or II element.

28. The packaging material of claim 27, wherein the weak basic composition is selected from the group consisting of sodium carbonate, calcium carbonate, and combinations thereof.

29. The packaging material of claim 26, wherein the weak acid composition is vinegar.

30. The packaging material of claim 21, wherein the exterior surface of the flexible inflatable bag includes a decorative effect.

31. A packaging material, comprising:
a flexible inflatable substrate having an exterior surface and an interior surface, the interior surface defining an expandable interior inflation space;
a means for inflating the expandable interior inflation space of the flexible inflatable substrate; and
at least one strip, strand, or unit of material disposed on the exterior surface of the flexible inflatable substrate to provide a packaging material.

32. The packaging material of claim 31, further including means for inflating the flexible inflatable bag.

33. The packaging material of claim 32, wherein the means for inflating the flexible inflatable bag is disposed in the expandable interior inflation space of the flexible inflatable bag.

34. The packaging material of claim 32, wherein the means for inflating the flexible inflatable bag is associated with the exterior surface of the flexible bag and is in fluid communication with the expandable interior inflation space of the flexible inflatable bag.

35. The packaging material of claim 33, wherein the means for inflating the flexible inflatable bag includes an exothermic reaction assembly, wherein when the exothermic reaction assembly is activated, an exothermic reaction takes place thereby producing a gas capable of filling at least a portion of the expandable interior inflation space of the flexible bag.

36. The packaging material of claim 35, wherein the exothermic reaction assembly further includes at least two chambers, wherein at least one of the at least two chambers contains a weak basic composition, and at least one of the at least two chambers contains a weak acid composition.

37. The packaging material of claim 36, wherein the weak basic composition is a composition including a Group I or II element.

38. The packaging material of claim 37, wherein the weak basic composition is selected from the group consisting of sodium carbonate, calcium carbonate, and combinations thereof.

39. The packaging material of claim 36, wherein the weak acid composition is vinegar.

40. The packaging material of claim 31, wherein the exterior surface of the flexible inflatable bag includes a decorative effect.

41. A method for making a flexible inflatable packaging material, comprising the steps of:
providing a flexible inflatable substrate having an exterior surface and an interior surface, the interior surface defining an expandable interior inflation space;
providing a means for inflating the expandable interior inflation space of the flexible inflatable substrate; and
providing at least one strip, strand, or unit of material, wherein the at least one strip, strand, or unit of material is disposed on the exterior surface of the flexible inflatable substrate to provide a flexible inflatable packaging material.

42. The packaging material of claim 41, further including means for inflating the flexible inflatable bag.

43. The packaging material of claim 42, wherein the means for inflating the flexible inflatable bag is disposed in the expandable interior inflation space of the flexible inflatable bag.

44. The packaging material of claim 42, wherein the means for inflating the flexible inflatable bag is associated with the exterior surface of the flexible bag and is in fluid communication with the expandable interior inflation space of the flexible inflatable bag.

45. The packaging material of claim 43, wherein the means for inflating the flexible inflatable bag includes an exothermic reaction assembly, wherein when the exothermic reaction assembly is activated, an exothermic reaction takes place thereby producing a gas capable of filling at least a portion of the expandable interior inflation space of the flexible bag.

46. The packaging material of claim 45, wherein the exothermic reaction assembly further includes at least two chambers, wherein at least one of the at least two chambers contains a weak basic composition, and at least one of the at least two chambers contains a weak acid composition.

47. The packaging material of claim 46, wherein the weak basic composition is a composition including a Group I or II element.

48. The packaging material of claim 47, wherein the weak basic composition is selected from the group consisting of sodium carbonate, calcium carbonate, and combinations thereof.

49. The packaging material of claim 46, wherein the weak acid composition is vinegar.

50. The packaging material of claim 41, wherein the exterior surface of the flexible inflatable bag includes a decorative effect.

51. A flexible inflatable packaging material produced according to the process comprising the steps of:
providing a flexible inflatable substrate having an exterior surface and an interior surface, the interior surface defining an expandable interior inflation space;
providing a means for inflating the expandable interior inflation space of the flexible inflatable substrate; and
providing at least one strip, strand, or unit of material, wherein the at least one strip, strand, or unit of material is disposed on the exterior surface of the flexible inflatable substrate to provide a flexible inflatable packaging material.

52. The packaging material of claim 51, further including means for inflating the flexible inflatable bag.

53. The packaging material of claim 52, wherein the means for inflating the flexible inflatable bag is disposed in the expandable interior inflation space of the flexible inflatable bag.

54. The packaging material of claim 52, wherein the means for inflating the flexible inflatable bag is associated with the exterior surface of the flexible bag and is in fluid communication with the expandable interior inflation space of the flexible inflatable bag.

55. The packaging material of claim 53, wherein the means for inflating the flexible inflatable bag includes an exothermic reaction assembly, wherein when the exothermic reaction assembly is activated, an exothermic reaction takes place thereby producing a gas capable of filling at least a portion of the expandable interior inflation space of the flexible bag.

56. The packaging material of claim 55, wherein the exothermic reaction assembly further includes at least two chambers, wherein at least one of the at least two chambers contains a weak basic composition, and at least one of the at least two chambers contains a weak acid composition.

57. The packaging material of claim 56, wherein the weak basic composition is a composition including a Group I or II element.

58. The packaging material of claim 57, wherein the weak basic composition is selected from the group consisting of sodium carbonate, calcium carbonate, and combinations thereof.

59. The packaging material of claim 56, wherein the weak acid composition is vinegar.

60. The packaging material of claim 51, wherein the exterior surface of the flexible inflatable bag includes a decorative effect.

61. A packaging material, comprising:
a flexible inflatable bag having an exterior surface and an interior surface, the interior surface defining an expandable interior inflation space; and
at least one organic item disposed on the exterior surface of the flexible inflatable bag.

62. The packaging material of claim 61, further including means for inflating the flexible inflatable bag.

63. The packaging material of claim 62, wherein the means for inflating the flexible inflatable bag is disposed in the expandable interior inflation space of the flexible inflatable bag.

64. The packaging material of claim 62, wherein the means for inflating the flexible inflatable bag is associated with the exterior surface of the flexible bag and is in fluid communication with the expandable interior inflation space of the flexible inflatable bag.

65. The packaging material of claim 63, wherein the means for inflating the flexible inflatable bag includes an exothermic reaction assembly, wherein when the exothermic reaction assembly is activated, an exothermic reaction takes place thereby producing a gas capable of filling at least a portion of the expandable interior inflation space of the flexible bag.

66. The packaging material of claim 65, wherein the exothermic reaction assembly further includes at least two chambers, wherein at least one of the at least two chambers contains a weak basic composition, and at least one of the at least two chambers contains a weak acid composition.

67. The packaging material of claim 66, wherein the weak basic composition is a composition including a Group I or II element.

68. The packaging material of claim 67, wherein the weak basic composition is selected from the group consisting of sodium carbonate, calcium carbonate, and combinations thereof.

69. The packaging material of claim 66, wherein the weak acid composition is vinegar.

70. The packaging material of claim 61, wherein the exterior surface of the flexible inflatable bag includes a decorative effect.

71. A method for making a flexible inflatable packaging material, comprising the steps of:
providing a flexible inflatable bag having an exterior surface and an interior surface, the interior surface defining an expandable interior inflation space; and
providing at least one organic item, the at least one organic item being disposed on the exterior surface of the flexible inflatable bag to form a flexible inflatable packaging material.

72. The packaging material of claim 71, further including means for inflating the flexible inflatable bag.

73. The packaging material of claim 72, wherein the means for inflating the flexible inflatable bag is disposed in the expandable interior inflation space of the flexible inflatable bag.

74. The packaging material of claim 72, wherein the means for inflating the flexible inflatable bag is associated with the exterior surface of the flexible bag and is in fluid communication with the expandable interior inflation space of the flexible inflatable bag.

75. The packaging material of claim 73, wherein the means for inflating the flexible inflatable bag includes an exothermic reaction assembly, wherein when the exothermic reaction assembly is activated, an exothermic reaction takes place thereby producing a gas capable of filling at least a portion of the expandable interior inflation space of the flexible bag.

76. The packaging material of claim 75, wherein the exothermic reaction assembly further includes at least two chambers, wherein at least one of the at least two chambers contains a weak basic composition, and at least one of the at least two chambers contains a weak acid composition.

77. The packaging material of claim 76, wherein the weak basic composition is a composition including a Group I or II element.

78. The packaging material of claim 77, wherein the weak basic composition is selected from the group consisting of sodium carbonate, calcium carbonate, and combinations thereof.

79. The packaging material of claim 76, wherein the weak acid composition is vinegar.

80. The packaging material of claim 71, wherein the exterior surface of the flexible inflatable bag includes a decorative effect.

81. A flexible inflatable packaging material produced according to the process comprising the steps of:
providing a flexible inflatable bag having an exterior surface and an interior surface, the interior surface defining an expandable interior inflation space; and
providing at least one organic item, the at least one organic item being disposed on the exterior surface of the flexible inflatable bag to form a flexible inflatable packaging material.

82. The packaging material of claim 81, further including means for inflating the flexible inflatable bag.

83. The packaging material of claim 82, wherein the means for inflating the flexible inflatable bag is disposed in the expandable interior inflation space of the flexible inflatable bag.

84. The packaging material of claim 82, wherein the means for inflating the flexible inflatable bag is associated with the exterior surface of the flexible bag and is in fluid communication with the expandable interior inflation space of the flexible inflatable bag.

85. The packaging material of claim 83, wherein the means for inflating the flexible inflatable bag includes an exothermic reaction assembly, wherein when the exothermic reaction assembly is activated, an exothermic reaction takes place thereby producing a gas capable of filling at least a portion of the expandable interior inflation space of the flexible bag.

86. The packaging material of claim 85, wherein the exothermic reaction assembly further includes at least two chambers, wherein at least one of the at least two chambers contains a weak basic composition, and at least one of the at least two chambers contains a weak acid composition.

87. The packaging material of claim 86, wherein the weak basic composition is a composition including a Group I or II element.

88. The packaging material of claim 87, wherein the weak basic composition is selected from the group consisting of sodium carbonate, calcium carbonate, and combinations thereof.

89. The packaging material of claim 86, wherein the weak acid composition is vinegar.

90. The packaging material of claim 81, wherein the exterior surface of the flexible inflatable bag includes a decorative effect.

91. A flexible inflatable packaging material produced according to the process comprising the steps of:
providing a flexible inflatable bag having an exterior surface and an interior surface, the interior surface defining an expandable interior inflation space; and
providing at least one organic item, wherein the at least one organic item is disposed on the exterior surface of the flexible inflatable bag to provide a flexible inflatable packaging material.

92. The packaging material of claim 91, further including means for inflating the flexible inflatable bag.

93. The packaging material of claim 92, wherein the means for inflating the flexible inflatable bag is disposed in the expandable interior inflation space of the flexible inflatable bag.

94. The packaging material of claim 92, wherein the means for inflating the flexible inflatable bag is associated with the exterior surface of the flexible bag and is in fluid communication with the expandable interior inflation space of the flexible inflatable bag.

95. The packaging material of claim 93, wherein the means for inflating the flexible inflatable bag includes an exothermic reaction assembly, wherein when the exothermic reaction assembly is activated, an exothermic reaction takes place thereby producing a gas capable of filling at least a portion of the expandable interior inflation space of the flexible bag.

96. The packaging material of claim 95, wherein the exothermic reaction assembly further includes at least two chambers, wherein at least one of the at least two chambers contains a weak basic composition, and at least one of the at least two chambers contains a weak acid composition.

97. The packaging material of claim 96, wherein the weak basic composition is a composition including a Group I or II element.

98. The packaging material of claim 97, wherein the weak basic composition is selected from the group consisting of sodium carbonate, calcium carbonate, and combinations thereof.

99. The packaging material of claim 96, wherein the weak acid composition is vinegar.

100. The packaging material of claim 91, wherein the exterior surface of the flexible inflatable bag includes a decorative effect.

101. A packaging material, comprising:
a flexible inflatable substrate having an exterior surface and an interior surface, the interior surface defining an expandable interior inflation space;
a means for inflating the expandable interior inflation space of the flexible inflatable substrate; and
at least one organic item disposed on the exterior surface of the flexible inflatable substrate.

102. The packaging material of claim 101, further including means for inflating the flexible inflatable bag.

103. The packaging material of claim 102, wherein the means for inflating the flexible inflatable bag is disposed in the expandable interior inflation space of the flexible inflatable bag.

104. The packaging material of claim 102, wherein the means for inflating the flexible inflatable bag is associated with the exterior surface of the flexible bag and is in fluid communication with the expandable interior inflation space of the flexible inflatable bag.

105. The packaging material of claim 103, wherein the means for inflating the flexible inflatable bag includes an exothermic reaction assembly, wherein when the exothermic reaction assembly is activated, an exothermic reaction takes place thereby producing a gas capable of filling at least a portion of the expandable interior inflation space of the flexible bag.

106. The packaging material of claim 105, wherein the exothermic reaction assembly further includes at least two chambers, wherein at least one of the at least two chambers contains a weak basic composition, and at least one of the at least two chambers contains a weak acid composition.

107. The packaging material of claim 106, wherein the weak basic composition is a composition including a Group I or II element.

108. The packaging material of claim 107, wherein the weak basic composition is selected from the group consisting of sodium carbonate, calcium carbonate, and combinations thereof.

109. The packaging material of claim 106, wherein the weak acid composition is vinegar.

110. The packaging material of claim 101, wherein the exterior surface of the flexible inflatable bag includes a decorative effect.

111. A method for making a flexible inflatable packaging material, comprising the steps of:
providing a flexible inflatable substrate having an exterior surface and an interior surface, the interior surface defining an expandable interior inflation space;
providing a means for inflating the expandable interior inflation space of the flexible inflatable substrate; and
providing at least one organic item, the at least one organic item being disposed on the exterior surface of the flexible inflatable substrate to form a flexible inflatable packaging material.

112. The packaging material of claim 111, further including means for inflating the flexible inflatable bag.

113. The packaging material of claim 112, wherein the means for inflating the flexible inflatable bag is disposed in the expandable interior inflation space of the flexible inflatable bag.

114. The packaging material of claim 112, wherein the means for inflating the flexible inflatable bag is associated with the exterior surface of the flexible bag and is in fluid communication with the expandable interior inflation space of the flexible inflatable bag.

115. The packaging material of claim 113, wherein the means for inflating the flexible inflatable bag includes an exothermic reaction assembly, wherein when the exothermic reaction assembly is activated, an exothermic reaction takes place thereby producing a gas capable of filling at least a portion of the expandable interior inflation space of the flexible bag.

116. The packaging material of claim 115, wherein the exothermic reaction assembly further includes at least two chambers, wherein at least one of the at least two chambers contains a weak basic composition, and at least one of the at least two chambers contains a weak acid composition.

117. The packaging material of claim 116, wherein the weak basic composition is a composition including a Group I or II element.

118. The packaging material of claim 117, wherein the weak basic composition is selected from the group consisting of sodium carbonate, calcium carbonate, and combinations thereof.

119. The packaging material of claim 116, wherein the weak acid composition is vinegar.

120. The packaging material of claim 111, wherein the exterior surface of the flexible inflatable bag includes a decorative effect.

121. A flexible inflatable packaging material produced according to the process comprising the steps of:
providing a flexible inflatable substrate having an exterior surface and an interior surface, the interior surface defining an expandable interior inflation space;
providing a means for inflating the expandable interior inflation space of the flexible inflatable substrate; and
providing at least one organic item, the at least one organic item being disposed on the exterior surface of the flexible inflatable substrate to form a flexible inflatable packaging material.

122. The packaging material of claim 121, further including means for inflating the flexible inflatable bag.

123. The packaging material of claim 122, wherein the means for inflating the flexible inflatable bag is disposed in the expandable interior inflation space of the flexible inflatable bag.

124. The packaging material of claim 122, wherein the means for inflating the flexible inflatable bag is associated with the exterior surface of the flexible bag and is in fluid communication with the expandable interior inflation space of the flexible inflatable bag.

125. The packaging material of claim 123, wherein the means for inflating the flexible inflatable bag includes an exothermic reaction assembly, wherein when the exothermic reaction assembly is activated, an exothermic reaction takes place thereby producing a gas capable of filling at least a portion of the expandable interior inflation space of the flexible bag.

126. The packaging material of claim 125, wherein the exothermic reaction assembly further includes at least two chambers, wherein at least one of the at least two chambers contains a weak basic composition, and at least one of the at least two chambers contains a weak acid composition.

127. The packaging material of claim 126, wherein the weak basic composition is a composition including a Group I or II element.

128. The packaging material of claim 127, wherein the weak basic composition is selected from the group consisting of sodium carbonate, calcium carbonate, and combinations thereof.

129. The packaging material of claim 126, wherein the weak acid composition is vinegar.

130. The packaging material of claim 121, wherein the exterior surface of the flexible inflatable bag includes a decorative effect.

131. A packaging material, comprising:
a flexible inflatable bag having an exterior surface and an interior surface, the interior surface defining an expandable interior inflation space; and
at least one inorganic item disposed on the exterior surface of the flexible inflatable bag.

132. The packaging material of claim 131, further including means for inflating the flexible inflatable bag.

133. The packaging material of claim 132, wherein the means for inflating the flexible inflatable bag is disposed in the expandable interior inflation space of the flexible inflatable bag.

134. The packaging material of claim 132, wherein the means for inflating the flexible inflatable bag is associated with the exterior surface of the flexible bag and is in fluid communication with the expandable interior inflation space of the flexible inflatable bag.

135. The packaging material of claim 133, wherein the means for inflating the flexible inflatable bag includes an exothermic reaction assembly, wherein when the exothermic reaction assembly is activated, an exothermic reaction takes place thereby producing a gas capable of filling at least a portion of the expandable interior inflation space of the flexible bag.

136. The packaging material of claim 135, wherein the exothermic reaction assembly further includes at least two chambers, wherein at least one of the at least two chambers contains a weak basic composition, and at least one of the at least two chambers contains a weak acid composition.

137. The packaging material of claim 136, wherein the weak basic composition is a composition including a Group I or II element.

138. The packaging material of claim 137, wherein the weak basic composition is selected from the group consisting of sodium carbonate, calcium carbonate, and combinations thereof.

139. The packaging material of claim 136, wherein the weak acid composition is vinegar.

140. The packaging material of claim 131, wherein the exterior surface of the flexible inflatable bag includes a decorative effect.

141. A method for making a flexible inflatable packaging material, comprising the steps of:
providing a flexible inflatable bag having an exterior surface and an interior surface, the interior surface defining an expandable interior inflation space; and
providing at least one inorganic item, the at least one inorganic item being disposed on the exterior surface of the flexible inflatable bag to form a flexible inflatable packaging material.

142. The packaging material of claim 141, further including means for inflating the flexible inflatable bag.

143. The packaging material of claim 142, wherein the means for inflating the flexible inflatable bag is disposed in the expandable interior inflation space of the flexible inflatable bag.

144. The packaging material of claim 142, wherein the means for inflating the flexible inflatable bag is associated with the exterior surface of the flexible bag and is in fluid communication with the expandable interior inflation space of the flexible inflatable bag.

145. The packaging material of claim 143, wherein the means for inflating the flexible inflatable bag includes an exothermic reaction assembly, wherein when the exothermic reaction assembly is activated, an exothermic reaction takes place thereby producing a gas capable of filling at least a portion of the expandable interior inflation space of the flexible bag.

146. The packaging material of claim 145, wherein the exothermic reaction assembly further includes at least two chambers, wherein at least one of the at least two chambers contains a weak basic composition, and at least one of the at least two chambers contains a weak acid composition.

147. The packaging material of claim 146, wherein the weak basic composition is a composition including a Group I or II element.

148. The packaging material of claim 147, wherein the weak basic composition is selected from the group consisting of sodium carbonate, calcium carbonate, and combinations thereof.

149. The packaging material of claim 146, wherein the weak acid composition is vinegar.

150. The packaging material of claim 141, wherein the exterior surface of the flexible inflatable bag includes a decorative effect.

151. A flexible inflatable packaging material produced according to the process comprising the steps of:
providing a flexible inflatable bag having an exterior surface and an interior surface, the interior surface defining an expandable interior inflation space; and
providing at least one inorganic item, the at least one inorganic item being disposed on the exterior surface of the flexible inflatable bag to form a flexible inflatable packaging material.

152. The packaging material of claim 151, further including means for inflating the flexible inflatable bag.

153. The packaging material of claim 152, wherein the means for inflating the flexible inflatable bag is disposed in the expandable interior inflation space of the flexible inflatable bag.

154. The packaging material of claim 152, wherein the means for inflating the flexible inflatable bag is associated with the exterior surface of the flexible bag and is in fluid communication with the expandable interior inflation space of the flexible inflatable bag.

155. The packaging material of claim 153, wherein the means for inflating the flexible inflatable bag includes an exothermic reaction assembly, wherein when the exothermic reaction assembly is activated, an exothermic reaction takes place thereby producing a gas capable of filling at least a portion of the expandable interior inflation space of the flexible bag.

156. The packaging material of claim 155, wherein the exothermic reaction assembly further includes at least two chambers, wherein at least one of the at least two chambers contains a weak basic composition, and at least one of the at least two chambers contains a weak acid composition.

157. The packaging material of claim 156, wherein the weak basic composition is a composition including a Group I or II element.

158. The packaging material of claim 157, wherein the weak basic composition is selected from the group consisting of sodium carbonate, calcium carbonate, and combinations thereof.

159. The packaging material of claim 156, wherein the weak acid composition is vinegar.

160. The packaging material of claim 151, wherein the exterior surface of the flexible inflatable bag includes a decorative effect.

161. A packaging material, comprising:
a flexible inflatable substrate having an exterior surface and an interior surface, the interior surface defining an expandable interior inflation space;
means for inflating the expandable interior inflation space of the flexible inflatable substrate; and
at least one inorganic item disposed on the exterior surface of the flexible inflatable substrate.

162. The packaging material of claim 161, further including means for inflating the flexible inflatable bag.

163. The packaging material of claim 162, wherein the means for inflating the flexible inflatable bag is disposed in the expandable interior inflation space of the flexible inflatable bag.

164. The packaging material of claim 162, wherein the means for inflating the flexible inflatable bag is associated with the exterior surface of the flexible bag and is in fluid communication with the expandable interior inflation space of the flexible inflatable bag.

165. The packaging material of claim 163, wherein the means for inflating the flexible inflatable bag includes an exothermic reaction assembly, wherein when the exothermic reaction assembly is activated, an exothermic reaction takes place thereby producing a gas capable of filling at least a portion of the expandable interior inflation space of the flexible bag.

166. The packaging material of claim 165, wherein the exothermic reaction assembly further includes at least two chambers, wherein at least one of the at least two chambers contains a weak basic composition, and at least one of the at least two chambers contains a weak acid composition.

167. The packaging material of claim 166, wherein the weak basic composition is a composition including a Group I or II element.

168. The packaging material of claim 167, wherein the weak basic composition is selected from the group consisting of sodium carbonate, calcium carbonate, and combinations thereof.

169. The packaging material of claim 166, wherein the weak acid composition is vinegar.

170. The packaging material of claim 161, wherein the exterior surface of the flexible inflatable bag includes a decorative effect.

171. A method for making a flexible inflatable packaging material, comprising the steps of:
providing a flexible inflatable substrate having an exterior surface and an interior surface, the interior surface defining an expandable interior inflation space;
providing a means for inflating the expandable interior inflation space of the flexible inflatable substrate; and
providing at least one inorganic item, the at least one inorganic item being disposed on the exterior surface of the flexible inflatable substrate to form a flexible inflatable packaging material.

172. The packaging material of claim 171, further including means for inflating the flexible inflatable bag.

173. The packaging material of claim 172, wherein the means for inflating the flexible inflatable bag is disposed in the expandable interior inflation space of the flexible inflatable bag.

174. The packaging material of claim 172, wherein the means for inflating the flexible inflatable bag is associated with the exterior surface of the flexible bag and is in fluid communication with the expandable interior inflation space of the flexible inflatable bag.

175. The packaging material of claim 173, wherein the means for inflating the flexible inflatable bag includes an exothermic reaction assembly, wherein when the exothermic reaction assembly is activated, an exothermic reaction takes place thereby producing a gas capable of filling at least a portion of the expandable interior inflation space of the flexible bag.

176. The packaging material of claim 175, wherein the exothermic reaction assembly further includes at least two chambers, wherein at least one of the at least two chambers contains a weak basic composition, and at least one of the at least two chambers contains a weak acid composition.

177. The packaging material of claim 176, wherein the weak basic composition is a composition including a Group I or II element.

178. The packaging material of claim 177, wherein the weak basic composition is selected from the group consisting of sodium carbonate, calcium carbonate, and combinations thereof.

179. The packaging material of claim 176, wherein the weak acid composition is vinegar.

180. The packaging material of claim 171, wherein the exterior surface of the flexible inflatable bag includes a decorative effect.

181. A flexible inflatable packaging material produced according to the process comprising the steps of:
providing a flexible inflatable substrate having an exterior surface and an interior surface, the interior surface defining an expandable interior inflation space;
providing a means for inflating the expandable interior inflation space of the flexible inflatable substrate; and
providing at least one inorganic item, the at least one inorganic item being disposed on the exterior surface of the flexible inflatable substrate to form a flexible inflatable packaging material.

182. The packaging material of claim 181, further including means for inflating the flexible inflatable bag.

183. The packaging material of claim 182, wherein the means for inflating the flexible inflatable bag is disposed in the expandable interior inflation space of the flexible inflatable bag.

184. The packaging material of claim 182, wherein the means for inflating the flexible inflatable bag is associated with the exterior surface of the flexible bag and is in fluid communication with the expandable interior inflation space of the flexible inflatable bag.

185. The packaging material of claim 183, wherein the means for inflating the flexible inflatable bag includes an exothermic reaction assembly, wherein when the exothermic reaction assembly is activated, an exothermic reaction takes place thereby producing a gas capable of filling at least a portion of the expandable interior inflation space of the flexible bag.

186. The packaging material of claim 185, wherein the exothermic reaction assembly further includes at least two chambers, wherein at least one of the at least two chambers contains a weak basic composition, and at least one of the at least two chambers contains a weak acid composition.

187. The packaging material of claim 186, wherein the weak basic composition is a composition including a Group I or II element.

188. The packaging material of claim 187, wherein the weak basic composition is selected from the group consisting of sodium carbonate, calcium carbonate, and combinations thereof.

189. The packaging material of claim 186, wherein the weak acid composition is vinegar.

190. The packaging material of claim 181, wherein the exterior surface of the flexible inflatable bag includes a decorative effect.
